(19) United States
(12) Patent Application Publication
(10) Pub. No.: US 2008/0293541 A1
(43) Pub. Date: Nov. 27, 2008

(54) SYSTEM AND METHOD FOR SELECTING A TRANSMISSION GEAR RATIO

(76) Inventors: Fadi S. Kanafani, Windsor (CA); Brian P. Gebby, Ferndale, MI (US); Michael J. Prucka, Ann Arbor, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/753,782

(22) Filed: May 25, 2007

(51) Int. Cl. B60W 10/00; B60W 10/04; B60W 10/10; F16H 59/48; F16H 61/10; G06G 7/70

(52) U.S. Cl. 477/110; 477/120; 477/128; 701/123; 701/55; 701/95

(57) ABSTRACT

An automatic transmission control system includes a shift map that includes predetermined ranges of vehicle speeds at which vehicle engine speeds require gear shifts for the automatic transmission based on requests for torque. The predetermined ranges include upper bounds that correspond to gear upshifts and lower bounds that correspond to gear down shifts. A shift map control module varies at least one of the predetermined ranges of vehicle speeds based on at least one vehicle condition that affects movement of the vehicle.

The present disclosure relates to transmissions, and more particularly to automatic transmissions.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Automatic transmissions usually include multiple gears, which provide different gear ratios between wheels and an engine of a vehicle. Speed and torque transmitted to the wheels are adjusted by shifting the transmission from one gear ratio to another. Automatic transmissions may include hydraulic or electric control systems, which monitor engine speed, throttle position and a number of other variables that indicate vehicle speed and road conditions.

A powertrain control module (PCM), which may also be referred to as an engine control module (ECM), controls both the engine and transmission. The PCM positions the transmission in the proper gear ratio to maximize vehicle performance and fuel economy.

The PCM may include an “adaptive” control system that enables the transmission to adapt to changing conditions. For adaptive control, the PCM may operate based on shifting schedules, which are often stored in vehicle memory. Shift schedules are generally optimized for normal operating conditions and quite often attempt to balance the fuel economy and performance of the vehicle. The PCM, however, may initiate repetitive upshifting and downshifting of the automatic transmission as the PCM follows the predetermined shift schedules.

Repeated upshifts and downshifts may negatively affect overall sound and feel of the vehicle. For example, when traveling uphill on a steep incline and/or with a heavy vehicle load, the automatic transmission may repeatedly upshift and downshift between gears in order to attempt to maintain the desired vehicle speed.

### SUMMARY

An automatic transmission control system includes a shift map that includes predetermined ranges of vehicle speeds at which vehicle engine speeds require gear shifts for the automatic transmission based on requests for torque. The predetermined ranges include upper bounds that correspond to gear upshifts and lower bounds that correspond to gear down shifts. A shift map control module varies at least one of the predetermined ranges of vehicle speeds based on at least one vehicle condition that affects movement of the vehicle.

In other features, a powertraln control system for a vehicle includes a driver input sensing module that determines vehicle operator torque requests. The system also includes a vehicle speed sensing module that detects vehicle speed and an engine speed sensing module that detects engine speed. The system also includes a vehicle condition sensor that senses at least one vehicle condition that affects movement of the vehicle.

A shift map comprises M discrete gear shift parameters that correspond to the vehicle speeds at which the vehicle engine speeds require gear shifts and a variogram that includes predetermined default upper and lower hysteresis bands for each of the U discrete gear shift parameters. The default upper and lower hysteresis bands correspond to optimal shift points for the automatic step transmission based on the vehicle operator torque requests.

A shift map control module varies at least one of the upper and lower hysteresis bands in relation to a respective one of the M discrete gear shift parameters based on the at least one vehicle condition. The shift map control module generates a shift control signal based on the variogram.

Further areas of applicability of the present disclosure will become apparent from the detailed description provided hereinafter. If should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic diagram of a vehicle powertrain system according to the present disclosure;

FIG. 2 is a graphical representation of a variogram according to the present disclosure;

FIG. 3 is a schematic diagram of a vehicle powertrain system according to the present disclosure; and

FIG. 4 is a flowchart of a method for operating a vehicle powertrain system according to the present disclosure.

### DETAILED DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, 8, and C should be construed to mean a logical (A or B or C), using a non-exclusive logical or. It should be understood that steps within a method may be executed in different order without altering the principles of the present disclosure.

As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality.

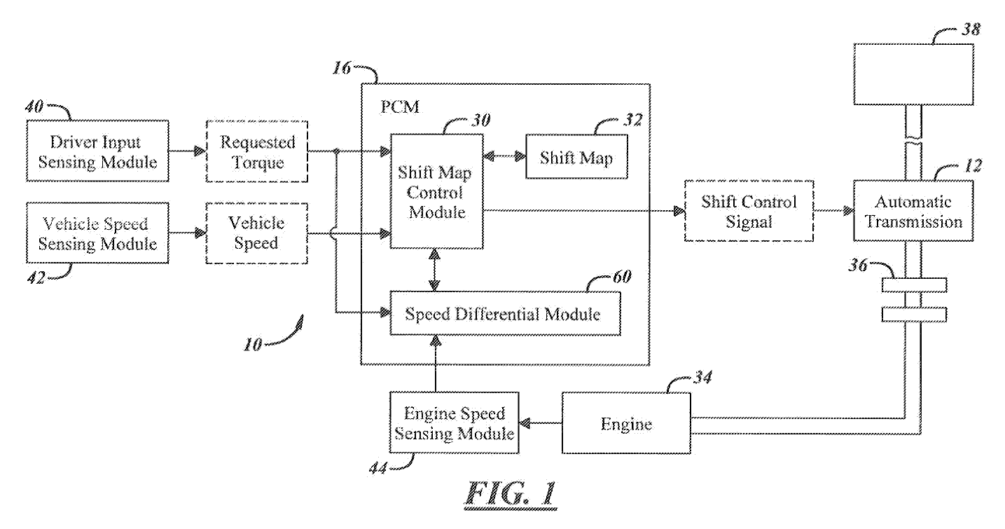

Referring now to FIG. 1, a powertrain system 10 of a vehicle includes an automatic step transmission 12 that is controlled by a powertrain control module (PCM) 18. The PCM 16 may include a shift map control module 30 that controls gear shifting operations based on a shift map 32, which may be a variogram. It should be appreciated that transmission control routines discussed herein could alternately be provided in other control devices, such as a transmission control module (TCM).

The system 10 includes an engine 34 that may be coupled to a torque converter 38. The torque converter 38 may in turn be coupled to the automatic transmission 12. The automatic transmission 12 may communicate through a differential (not shown) to the wheels 38. The engine speed may correspond to a selected output gear speed for the transmission 12. Accordingly, the PCM 16 selects gears using the value of the engine speed in place of the selected gear hereinafter.

The PCM 18 receives various vehicle parameters such as requested torque, vehicle speed, and engine speed. The PCM 16 determines when to shift among the various gears of the automatic transmission 12 from a driver input sensing module 40, a vehicle speed sensing module 42, and an engine speed sensing module 44 based upon the predetermined variogram shift schedule and the vehicle parameters. In doing so, the PCM 16 outputs a shift control signal to the automatic transmission 12 that may correspond to a desired engine speed that controls upshifting and downshifting.

The PCM 10 may receive various other inputs such as a brake switch signal, coolant temperature, ambient temperature, battery, distributor and ignition switch information as is generally provided to powertrain control module in a vehicle. It should also be understood that the PCM 16 may receive various other signals such as a pressure switch input, a driver selected transmission position (PRNDL) signal, which provides an indication of the manually selectable transmission operating mode, a manifold pressure (MAP) signal, cruise control signals, vehicle load signals and brake signals. The PCM 16 may also receive various signals via a communication line or network, such as a vehicle bus.

The driver input sensing module 40 may sense/determine a rate of change in an accelerator pedal position on a percentage/amount the pedal is depressed, and this may correspond to a requested torque from the engine. The vehicle speed sensing module 42 may sense a vehicle speed, and the engine speed sensing module 44 may sense a speed of the engine 34. The PCM 16 may control the rate of change of gears in the automatic transmission 12 based on the vehicle and engine speeds and the accelerator pedal position/torque requests.

The shift map control module 30 may select/determine gear ratios during acceleration when, for example, the driver of the vehicle depresses the accelerator (not shown) to request a torque from the vehicle. This requested torque may be determined by a voltage sensor that determines the position of the pedal (not shown). The requested torque along with the current vehicle speed may be received by the shift map control module 30.

The PCM 16 may determine a difference between a desired engine speed and a current engine speed in a speed differential module 60. The speed differential module 80 may also determine a rate of increase of engine speed necessary to attain the desired engine speed.

One method for controlling the gear ratio of the automatic transmission 12 according to the present disclosure is to use predefined variograms. Variograms relate vehicle speed to requested torque to determine an engine speed. The engine speed, along with the vehicle speed, may he used to calculate a gear ratio for the automatic transmission. Various different variograms may be used for different requests for torque, such as those that occur during economical fuel efficient driving and sport/performance driving.

The shift map control module 30 may determine a desired engine speed, in the particular example provided, the requested torque and the current vehicle speed are each fed into a variogram 32. The variogram 32 may include a gear ratio map calibrated to provide an optimal fuel economy.

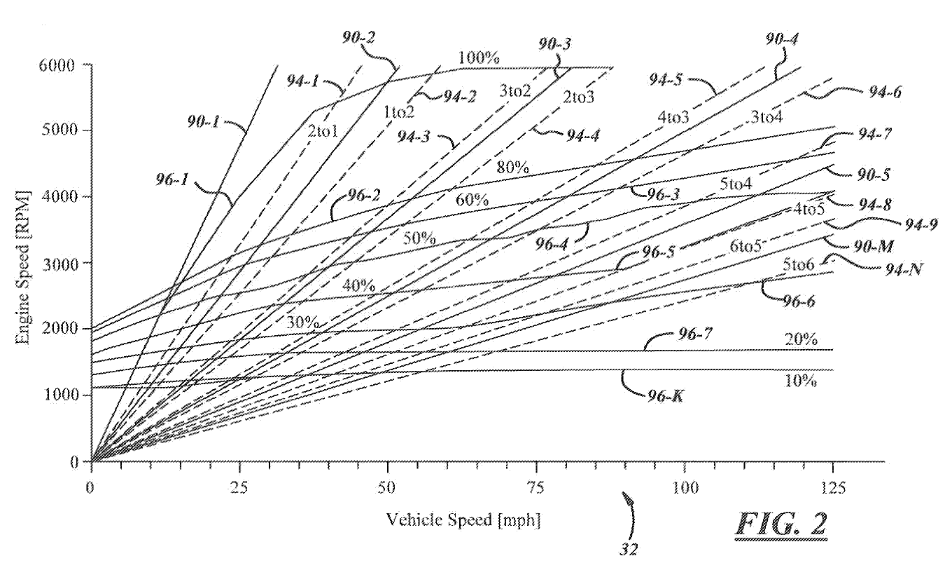

Referring now to FIG. 2, an exemplary variogram 32 is provided. The variogram 32 may include a graph of vehicle speed versus engine speed and may include gear ratio shift lines 80-1, 90-2, . . . , and 90-M (collectively referred to as shift lines 90) with respective hysteresis bands/lines 94-1, 94-2, . . . , and 94-N (collectively referred to as hysteresis bands 94), that indicate an adjustable range for shifting of the transmission or adjusting slip of the torque converter or input clutch. Torque request lines 96-1, 96-2, . . . , and 96-K (collectively referred to as torque request lines 98) are mapped onto the graph and are specific to the type of variogram being used. For example, the torque request lines 06 for the variogram 32 have varying slopes ranging from fairly horizontal (10% request for torque from the driver) to fairly vertical (100% request for torque from the driver). An economy variogram may have fairly straight horizontal torque request lines whereas a performance variogram may have torque request lines that include varying slopes similar to those illustrated.

Variogram outputs may correspond to engine speeds or desired engine speeds that can be divided by the vehicle speed. The result may indicate which gear will be preferable for the desired engine speed. The vehicle speed may be mapped against a torque request line, for example torque request line 96-4 (50%), corresponding to the requested torque. This mapping may correspond to a point within the variogram 32. The point, in turn, may correspond to a desired engine speed located on the Y axis of the variogram.

Each gear ratio shift line 90 may have a hysteresis line(s) 94, illustrated as two hysteresis lines, around it. The hysteresis lines 94 correspond to respective gear shifts. Generally, within the lines 94, a corresponding gear is commanded unless the shift map control module 30 has received data to delay or accelerate shifting. Each of the torque request lines 96 may eventually cross all of the shift lines 90. The hysteresis lines 94 may be moved in relation to each shift point along torque request lines 96 based on the operating condition of the vehicle.

In operation, the torque request line 96 on the variogram 32 of a selected pedal position is followed and intersects with the hysteresis lines 94. The transmission shifts when a certain output torque is demanded, for example, through application of the accelerator pedal. Assuming the driver applies the accelerator pedal 50% from launch, the transmission shifts from 1^{st} to 2^{nd} gear when the 50% line intersects the 1 to 2 hysteresis line as the vehicle accelerates. The transmission shifts from 2^{nd} to 3^{rd} gears when the 50% line intersects the 2 to 3 hysteresis line, and so on.

For example, the 50% torque request line 96-4 may cross the 2 to 1 hysteresis line 94-1 from the right and the 2^{nd} gear ratio line 90-2 without shifting and would then shift from 1^{st} to 2^{nd} gear when crossing the 1 to 2 hysteresis line 94-2.

The shift map control module 30 may adjust the hysteresis lines 94 from a default setting based on information indicating various vehicle conditions. The default setting may correspond to the vehicle traveling on a flat road with low wind resistance while not towing anything. For example, when sensor information is provided that indicates the vehicle is on a hill, the shift map control module 30 may move the 1 to 2 hysteresis line 94-2 over to the right. In other words, the 1 to 2 hysteresis line 94-2 may be delayed. The shift map control module 30 may determine that at a 50% torque request 96-4, for example, a 1^{st} to 2^{nd} gear shift occurs at 25 miles an hour. The adjustment of the hysteresis line 94-2 would delay the gear shift until the vehicle reaches 30-35 mph. In other words, the hysteresis lines 94 are moved around the first to second gear ratio shift line 90-2 based on actual conditions of the vehicle.

The variogram 32 allows the shift map control module 30 to define the optimal state for running the engine 34. The variogram provides a background of default optimal operating parameters to which the shift map control module 30 will return. Previous limited shift maps merely included sets of shift points that were not necessarily optimal for the vehicle. Therefore, previous automatic transmissions experienced operation limitations due to being constrained to a single shift schedule. The present disclosure includes, among other things, default conditions for optimal fuel economy.

The shift map control module 30 may adjust any or all of the hysteresis lines 94 based on whether the vehicle is in a fuel economy or performance mode. The shift map control module 30 may also adjust the hysteresis lines 94 based on noise, vibration, and/or harshness within the vehicle. Other parameters that may be used include cylinder deactivation availability (for example using a multi-displacement system (MDS)), oil temperature, wheel torque requests, fuel flow estimations, and torque converter lock-up availability. For example, when the transmission 12 is in a torque converter lock-up mode but the shift map control module 30 determines that shifting into a higher gear would result in an unlock condition and hence degraded fuel economy, the shift map control module 30 would not upshift but instead remain in lockup.

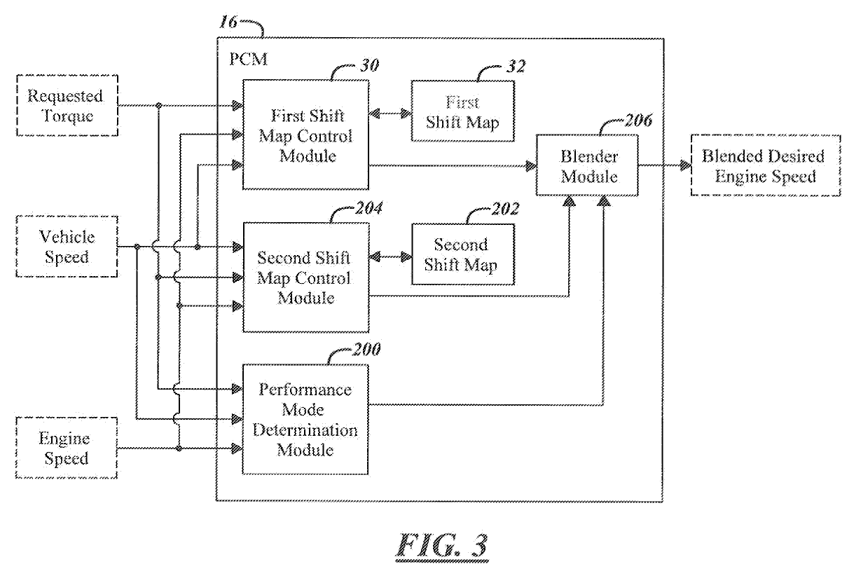

Referring now to FIG. 3, the requested torque, the vehicle speed, and the current engine speed of the vehicle may be input into a performance mode determination module 200 of the PCM 16. The performance mode determination module 200 uses the rates of the change of the position of the accelerator pedal (not shown) to determine whether the driver of the vehicle wishes to be in, for example, an economy mode of driving, a sports mode of driving, or any mode therebetween.

A high rate of change may indicate a desire for performance mode, while a slow rate of change may indicate a desire for an economy performance mode. Accordingly, the performance mode determination module 200 outputs a performance mode. The performance mode may be a weighted value corresponding to the preferred driving mode of the driver of the vehicle, and may range from an economy mode to a sports mode.

Using the above method, an infinite number of blends may be created between pairs of consecutive variograms. This allows for an unprecedented amount of customized “feel” for an automatic transmission. Multiple switchable driving modes may correspond to different variograms 32, 202, within multiple shift map control modules 30, 204. For example, a first variogram 32 may correspond to a sports drive mode; and a second variogram 202 may correspond to an economy drive mode. Both modes may be selectable by an operator of the vehicle. Multimode systems, however, force the driver to manually select between multiple variograms and do not allow for gear selection in between. Outputs of first and second shift map control modules 30, 204 are therefore blended in blender module 206, which generates a blended desired engine speed.

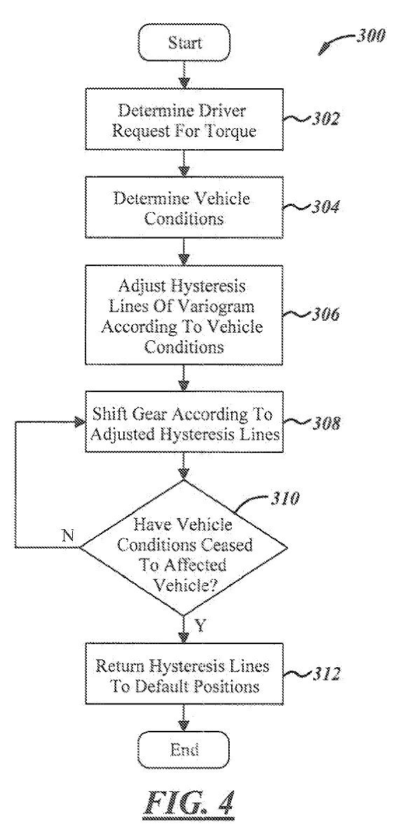

Referring now to FIG. 4, a flowchart 300 illustrates a method for operating the powertraln system. Control starts in step 302 when a driver request for torque is received. Such request may correspond to a relative depression of the acceleration pedal, in step 304, conditions affecting the vehicle, if any, are determined. In step 308, hysteresis lines of the variogram are adjusted according to any vehicle conditions from step 304. In step 308, the automatic step transmission is commanded to shift gears according to the modified/adjusted hysteresis lines. In step 310, if the vehicle conditions have ceased to affect the vehicle, then hysteresis lines are returned to default positions in step 312.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. An automatic transmission control system for a vehicle comprising:
a shift map that includes predetermined ranges of vehicle speeds at which vehicle engine speeds require gear shifts for the automatic transmission based on requests for torque, wherein said predetermined ranges include upper bounds that correspond to gear upshifts and lower bounds that correspond to gear down shifts; and
a shift map control module that varies at least one of said predetermined ranges of vehicle speeds based on at least one vehicle condition that affects movement of the vehicle.

2. The system of claim 1 wherein said shift map comprises a variogram.

3. The system of claim 1 further comprising at least one sensor that senses said at least one vehicle condition.

4. The system of claim 3 wherein said at least one vehicle condition is based on at least one of road grade, wind resistance, and load on the vehicle.

5. The system of claim 1 wherein said vehicle condition is based on at least one of noise within the vehicle, vibration within the vehicle, harshness within the vehicle, engine cylinder deactivation availability, oil temperature, wheel torque requests, fuel flow estimations, torque converter lock-up availability, longitudinal acceleration sensing from electronic stability systems, and altitude sensing from navigational system.

6. The system of claim 1 wherein said shift map control module varies only one of said upper and lower hounds.

7. A powertrain system comprising; the automatic transmission control system of claim 1 and the automatic transmission, wherein the automatic transmission comprises an automatic step transmission.

8. The powertrain system of claim 7 wherein said predetermined ranges each include respective steps of said automatic step transmission.

9. The powertrain system of claim 7 further comprising an accelerator pedal, wherein said requests for torque correspond to movements of said accelerator pedal.

10. The system of claim 1 wherein said shift map control module defaults to said predetermined ranges when said at least one condition ceases to affect movement of the vehicle.

11. An automatic step transmission control system for a vehicle comprising:
a shift map that comprises M discrete gear shift parameters that correspond to vehicle speeds at which vehicle engine speeds require gear shifts and a variogram that includes predetermined upper and lower hysteresis bands for each of said M discrete gear shift parameters that correspond to optimal shift points for the automatic step transmission based on requests for torque; and
a shift map control module that varies at least one of said upper and lower hysteresis bands in relation to a respective one of said M discrete gear shift parameters based on at least one vehicle condition that affects movement of the vehicle, and wherein said shift map control module generates a shift control signal based on said variogram.

12. The system of claim 11 further comprising at least one sensor that senses said at least one vehicle condition.

13. The system of claim 11 wherein said at least one vehicle condition is based on at least one of road grade, wind resistance, and load on the vehicle.

14. The system of claim 11 wherein said vehicle condition is based on at least one of noise within the vehicle, vibration within the vehicle, harshness within the vehicle, engine cylinder deactivation availability, oil temperature, wheel torque requests, fuel flow estimations, torque converter lock-up availability, longitudinal acceleration sensing from electronic stability systems, and altitude sensing from navigational system.

15. The system of claim 11 wherein said shift map control module varies only one of said predetermined upper and lower hysteresis bands.

16. A powertrain system comprising; the automatic transmission control system of claim 11 and the automatic step transmission, wherein the automatic step transmission shifts gears based on said shift control signal.

17. The system of claim 11 wherein said shift map control module, defaults, to said predetermined upper and lower hysteresis bands when said at least one condition ceases to affect movement of the vehicle.

18. A powertrain control system for a vehicle comprising:
a driver input sensing module that determines vehicle operator torque requests;
a vehicle speed sensing module that detects vehicle speeds of the vehicle;
an engine speed sensing module that defects engine speeds of the vehicle;
a vehicle condition sensor that senses at least one vehicle condition that affects movement of the vehicle;
a shift map that comprises M discrete gear shift parameters that correspond to said vehicle speeds at which said vehicle engine speeds require gear shifts and a variogram that includes predetermined default upper and lower hysteresis bands for each of said M discrete gear shift parameters that correspond to optimal shift points for the automatic step transmission based on said vehicle operator torque requests; and
a shift map control module that varies at least one of said upper and lower hysteresis bands in relation to a respective one of said M discrete gear shift parameters based on said at least one vehicle condition, and wherein said shift map control module generates a shift control signal based on said variogram.

19. The system of claim 18 wherein said variogram includes a graph that corresponds to at least one of optimized fuel economy and optimized sport performance.

20. The system of claim 18 wherein said shift map control module varies only one of said predetermined upper and lower hysteresis bands.
